(19) United States
(12) Patent Application Publication
(10) Pub. No.: US 2026/0203370 A1
(43) Pub. Date: Jul. 16, 2026

(54) CIRCUITRY FOR ACCELERATED MULTIPLICATION OF SPARSE MATRICES BY PARALLEL ACCUMULATION OPERATIONS

(71) Applicant: Numenta, Inc., Menlo Park, CA (US)

(72) Inventors: Robert Edward Liston, Menlo Park, CA (US); Subutai Ahmad, Palo Alto, CA (US); Paul Michael Farmwald, Atherton, CA (US)

(21) Appl. No.: 19/445,318

(22) Filed: Jan. 9, 2026

Related U.S. Application Data
(60) Provisional application No. 63/744,771, filed on Jan. 13, 2025.
(60) Provisional application No. 63/744,781, filed on Jan. 13, 2025.
(60) Provisional application No. 63/757,057, filed on Feb. 11, 2025.

(51) Int. Cl. G06F 17/16; G06N 3/0495

(52) U.S. Cl. CPC G06F 17/16; G06N 3/0495

(57) ABSTRACT

Embodiments relate to hardware circuitry that operates to perform efficient and expedient processing of sparse tensors in a neural network. The circuitry may assist one or more processors to perform repetitive operations on data from the sparse tensors in parallel to reduce overhead and enhance performance. The sparse tensors may be pre-processed to arrange or filter their elements so that the elements likely to yield important outputs are prioritized for processing. The circuitry may prioritize the assignment of limited memory space for accumulators to retrieve intermediate values for generating final values and store updated intermediate values or output values at a high speed.

### CROSS-REFERENCE TO RELATED APPLICATIONS

The present application claims the benefit of U.S. Provisional Patent Application No. 63/744,711, filed on Jan. 13, 2025, U.S. Provisional Patent Application No. 63/744,781, filed on Jan. 13, 2025, and U.S. Provisional Patent Application No. 63/757,057, filed on Feb. 11, 2025, which are incorporated by reference herein in their entirety.

### FIELD OF THE DISCLOSURE

The present disclosure relates to circuits for processing tensors, and more specifically to circuits for efficiently performing operations related to sparse tensors.

### BACKGROUND

The use of artificial neural networks (ANNs), or simply neural networks, includes a vast array of technologies. An ANN's complexity, in terms of the number of parameters, is growing exponentially at a faster rate than hardware performance. In many cases, an ANN may have a large number of parameters. Training and inference on these networks are bottlenecked by massive linear tensor operations, including multiplication and convolution. Many neural networks exhibit significant sparsity, where a substantial portion of tensor elements are zero or near-zero values. Consequently, a large amount of time and/or resources may be used for both ANN creation (e.g., training) and execution (e.g., inference), particularly when processing sparse tensors that contain irregular computation patterns and non-uniform memory access characteristics.

Computing systems that execute ANNs often involve extensive computing operations including multiplication and accumulation on both dense and sparse tensors. For example, convolutional neural networks (CNNs) primarily use convolution between input data and kernel data, which can be decomposed into multiplication and accumulation operations. Processing sparse tensors presents significant challenges across various processor architectures, including central processing units (CPUs), graphics processing units (GPUs), and specialized accelerators. These challenges include irregular parallelization, load imbalance between processing threads, memory access irregularities, and difficulties in efficiently storing intermediate sparse data.

Using a generic processor and its main memory to instantiate and execute machine learning systems or models is relatively straightforward, as such systems can be instantiated with mere updates to code. However, conventional approaches for sparse tensor operations on the generic processor often consume significant processing bandwidth and increase overall power consumption, particularly when handling the irregular computation patterns inherent in sparse tensor algebra.

### SUMMARY

Embodiments relate to a sparse processing circuit that generates mapping of indices of non-zero elements in a first tensor to locations of accumulators while assisting or enabling retrieval of stored accumulator values from the accumulators. The first tensor is derived from a sparse weight tensor to at least remove zero elements from the sparse weight tensor. The sparse processing circuit operates with one or more processors. The one or more processors receive and decode instructions for performing sparse tensor operations. The sparse processing circuit includes a plurality of iteration processor circuits and an associative mapping circuit. The iteration processor circuits generate mapping of a subset of indices of non-zero elements in a first tensor to locations of accumulators in memory by parallel processing the subset of indices. The associative mapping circuit assists or performs retrieving of accumulator values stored in the accumulators.

In one or more embodiments, the memory stores the non-zero elements in the first tensor and indices of the non-zero elements along a first dimension and the accumulated values of the accumulators. The memory may include one or more levels of cache, a system memory or a combination thereof. The memory also stores instructions that cause the one or more processors or the sparse processing circuit to retrieve accumulator values from accumulators corresponding to received indices, update the retrieved accumulator values by processing the non-zero elements of the first tensor corresponding to the received indices with non-zero elements of a second tensor in parallel, store the updated accumulator values in the mapped accumulators, and apply an activation function to the stored accumulator values to generate an output tensor.

In one or more embodiments, the sparse processing circuit skips mapping of the indices other than the subset of the indices to the accumulators in the memory. In this way, a limited number of accumulators may be used with priority given to important elements of the first tensor and the test tensor, and thereby, result in a more efficient use of resources.

In one or more embodiments, the first tensor has the non-zero elements along the first dimension sorted by one or more criteria of importance to place a first non-zero element with first importance ahead of a second non-zero element with second importance lower than the first importance and having a same index in the second dimension of the first tensor that is perpendicular to the first dimension.

In one or more embodiments, one or more indices of the non-zero elements along the first dimension are selected for each index along the second dimension based on magnitude or saliency metric representing the importance of the non-zero elements for the mapping the one or more criteria.

In one or more embodiments, non-zero elements of an input sparse activation tensor are sorted according to one or more criteria of importance to generate the second tensor sorted along a second dimension of the second tensor perpendicular to the first dimension of the second tensor. A first non-zero element of the input sparse activation tensor with first importance is placed ahead of a second non-zero element of the input sparse activation tensor with second importance lower than the first importance.

In one or more embodiments, the associative mapping circuit stores generated hash values of a subset of the indices along the second dimension. When request indices are received, which of the request indices have corresponding hash values in the associative mapping circuit are determined. A hit signal indicating which of the request indices have corresponding hash values in the pre-filtering circuit is sent to skip hash lookup for retrieving accumulator values associated with at least a subset of the request indices without the corresponding hash values in the associative mapping circuit.

In one or more embodiments, the one or more processors or the sparse processing circuit comprises a bitonic sorting network circuit that selects a subset of the stored accumulator values based on magnitude. The selected accumulator values are retained in the output tensor while unselected accumulator values are zeroed out in the output tensor.

In one or more embodiments, the associative mapping circuit includes a content addressable memory that stores the generated mapping.

In one or more embodiments, the one or more processors include a decoder circuit that decodes a first single instruction, multiple data (SIMD) instruction responsive to which the mapping is generated, and decodes a second SIMD instruction responsive to which the accumulator values are retrieved.

### BRIEF DESCRIPTION OF THE DRAWINGS

The teachings of the embodiments of the present invention can be readily understood by considering the following detailed description in conjunction with the accompanying drawings.

FIG. 1A is a conceptual diagram illustrating an example architecture of a neural network, according to an embodiment.

FIG. 1B is a block diagram illustrating an example operation in the neural network, according to an embodiment.

FIG. 2 is a diagram illustrating the concept of sparsity in a neural network, according to an embodiment.

FIG. 3 is a flowchart illustrating processing a sparse activation tensor and a sparse weight tensor, according to an embodiment.

FIG. 4A is a diagram illustrating a sparse weight tensor, according to an embodiment.

FIG. 4B is a diagram illustrating weights of rows in a sparse tensor that are sorted and filtered, according to an embodiment.

FIG. 5 is a block diagram of a computing device, according to an embodiment.

FIGS. 6A through 6D are block diagrams of processing circuitry, according to various embodiments.

FIG. 7 is a block diagram illustrating interactions among a processor, a sparse processing circuit and a memory system, according to an embodiment.

FIG. 8 is a block diagram illustrating the sparse processing circuit, according to an embodiment.

FIG. 9 is a diagram illustrating data stored in the memory system, according to an embodiment.

FIG. 10 is a block diagram of an associative mapping circuit using filter registers for pre-filtering, according to an embodiment.

FIGS. 11A and 11B are flowcharts illustrating the processes of using the filter registers to pre-filter indices, according to an embodiment.

FIG. 12 is a block diagram of an associative mapping circuit including a content addressable memory (CAM) to determine offset locations of accumulators in an accumulator table, according to an embodiment.

FIG. 13 is a flowchart illustrating the processes of using the CAM to determine the offset locations of the accumulators, according to an embodiment.

FIG. 14 is a flowchart illustrating the processes of storing offsets and keys in the CAM, according to one embodiment.

### DETAILED DESCRIPTION OF EMBODIMENTS

In the following description of embodiments, numerous specific details are set forth in order to provide more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left-most digit of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to the desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities such as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. A computer readable medium is a non-transitory medium that does not include propagation signals and transient waves. Furthermore, the computers referred to in the specification may include a single processor or may be architectures employing multiple processor designs for increased computing capability. Various embodiments described may also be implemented as field-programmable gate arrays (FPGAs), which include hardware programmable devices that accept programming commands to execute the processing of input data.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, embodiments are not described with reference to any particular programming language. It will be appreciated that a variety of programming languages may be used to implement the teachings as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter.

Embodiments relate to hardware circuitry that operates in conjunction with one or more processors to perform efficient and expedient processing of sparse tensors in a neural network. A sparse processing circuit may assist the one or more processors to perform repetitive operations on data from the sparse tensors in parallel to reduce overhead and enhance performance. The sparse tensors may be pre-processed to arrange or filter their elements so that the elements likely to yield important outputs are prioritized for processing. The sparse processing circuit may prioritize assigning of limited memory space to process and store such important outputs. The sparse processing circuit also includes circuit components that store intermediate values in the memory space and retrieve intermediate values with high speed. A subset of the produced outputs may then be selected for further processing such as forwarding to a next layer in the neural network. With the assistance of the sparse processing circuit, various types of processors may perform sparse tensor operations in an efficient manner using a lesser amount of computing resources.

### Example Sparse Neural Network

A sparse tensor has a large number of elements that are zero. The degree of sparsity for a sparse tensor may vary depending on embodiments. In one embodiment, the number of non-zero active values in a tensor is fewer than 50% to be considered a sparse tensor. In one embodiment, the number of active values in a tensor is fewer than 40% to be considered a sparse tensor. In one embodiment, the number of active values in a tensor is fewer than 30% to be considered a sparse tensor. In one embodiment, the number of active values in a tensor is fewer than 20% to be considered a sparse tensor while in others, the number of active values in a tensor is fewer than 15%, 10%, 5%, 4%, 3%, 2%, 1%, 0.8%, 0.5%, 0.2%, 0.1% or 0.01% to be considered a sparse tensor.

If many or most of the elements are zero, many or most of the intermediate products of a vector dot product or a matrix multiplication operation will be zero. Taking the example of a matrix-matrix multiplication, as the sparsity of both matrices increases, the number of non-zero intermediate products decreases exponentially. Hence, the amount of computation for performing a matrix multiplication on two sparse matrices may be orders of magnitude smaller if operands of zero are skipped, thereby reducing the processing time, the amount of data manipulation, arithmetic execution time and energy consumption.

A sparse tensor may be represented in compressed formats to balance memory saving and speedy access. Such formats include, but are not limited to, Compressed Sparse Row (CSR), Compressed Sparse Column (CSC), Coordinated List (COO) and various block-structured formats. Some of these formats reduce memory waste but result in increased overhead, memory traffic and slower access speed while others compromise memory reduction in favor of reduced overhead, memory traffic and higher access speed.

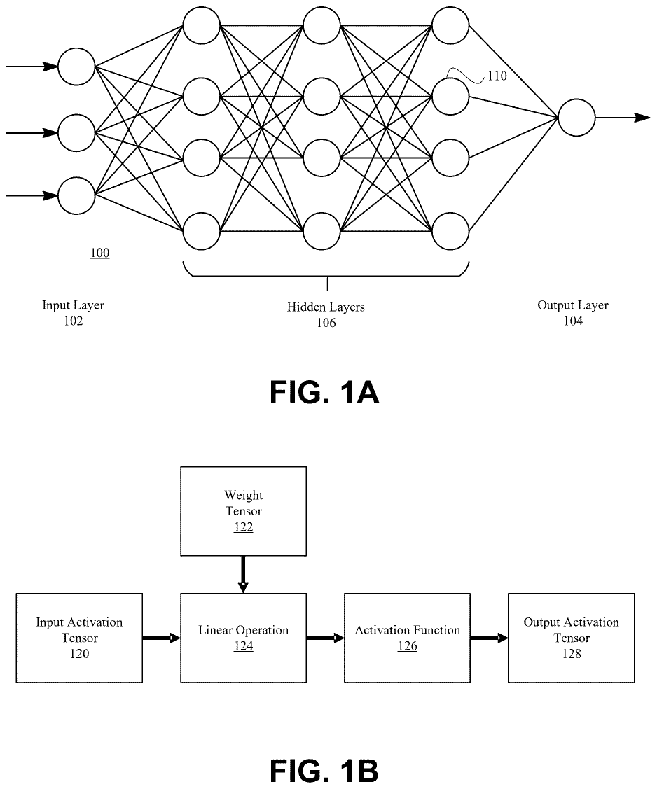

FIG. 1A is a conceptual diagram illustrating an example architecture of a neural network 100, according to an embodiment. The illustrated neural network 100 shows a generic structure of a neural network. Neural network 100 may represent different types of neural networks, including convolutional neural networks (CNNs), recurrent neural networks (RNNs), autoencoders, and long short term memory (LSTM). In various embodiments, customized changes may be made to this general structure. Neural network 100 may also be a hierarchical temporal memory system as described, for example, in U.S. Patent Application Publication No. 2020/0097857, published on May 26, 2020, which is incorporated herein by reference in its entirety.

Neural network 100 includes an input layer 102, an output layer 104 and one or more hidden layers 106. Input layer 102 is the first layer of neural network 100. Input layer 102 receives input data, such as image data, speech data, text, etc. Output layer 104 is the last layer of neural network 100. Output layer 104 may generate inferences in the form of classifications, probabilities and generated contents. Neural network 100 may include any number of hidden layers 106. Hidden layers 106 are intermediate layers in neural network 100 that perform various operations. Neural network 100 may include additional or fewer layers than the example shown in FIG. 1A. Each layer may include one or more nodes 110. The number of nodes in each layer in the neural network 100 shown in FIG. 1A is an example only. A node 110 may be associated with certain weights and activation functions. In various embodiments, the nodes 110 in neural network 100 may be fully connected or partially connected.

Each node 110 in neural network 100 may be associated with different operations. For example, in a simple form, neural network 100 may have nodes, each associated with a set of weights and an activation function. In another embodiment, neural network 100 may be an example convolutional neural network (CNN). In this example CNN, nodes 110 in one layer may be associated with convolution operations with kernels as weights that are adjustable in the training process. Nodes 110 in another layer may be associated with spatial pooling operations. In yet another embodiment, neural network 100 may be a recurrent neural network (RNN) whose nodes may be associated with more complicated structures such as loops and gates. In neural network 100, each node may represent a different structure and have different weight values and a different activation function.

FIG. 1B is a block diagram illustrating an example operation of a node 110 in neural network 100, according to an embodiment. A node 110 may receive an input activation tensor 120, which can be an N-dimensional tensor, where N may be greater than or equal to one. Input activation tensor 120 may be the input data of neural network 100 if node 110 is in the input layer 102. Input activation tensor 120 may also be the output of another node in the preceding layer. Node 110 may apply a weight tensor 122 to input activation tensor 120 in a linear operation 124, such as addition, scaling, biasing, tensor multiplication, and convolution in the case of a CNN. The result of linear operation 124 may be processed by activation function 126. The activation function may be, for example, a sparsity activation function such as a k-WTA function, a step function, a sigmoid function, a hyperbolic tangent function (tanh), and rectified linear unit functions (ReLU). The result of the activation function is an output activation tensor 128 that is sent to a subsequent layer of neural network 100. The subsequent node uses output activation tensor 128 as the input activation tensor 120.

In various embodiments, a wide variety of machine learning techniques may be used in training neural network 100. Neural network 100 may be associated with an objective function (also commonly referred to as a loss function), which generates a metric value that describes the objective goal of the training process. The training may intend to reduce the error rate of the model in generating predictions. In such a case, the objective function may monitor the error rate of neural network 100. For example, in object recognition (e.g., object detection and classification), the objective function of neural network 100 may be the training error rate in classifying objects in a training set. Other forms of objective functions may also be used. In various embodiments, the error rate may be measured as cross-entropy loss, L1 loss (e.g., the sum of absolute differences between the predicted values and the actual value), L2 loss (e.g., the sum of squared distances) or their combinations.

The weights and coefficients in the activation functions of neural network may be adjusted by training and also be constrained by sparsity and structural requirements. Training of neural network 100 may include forward propagation and backpropagation. In forward propagation, neural network 100 performs the computation in the forward direction based on outputs of a preceding layer. The operation of a node 110 may be defined by one or more functions, such as linear operation 124 and non-linear activation function 126. The functions that define the operation of a node 110 may include various computation operations such as convolution of data with one or more kernels, pooling, recurrent loop in RNN, various gates in LSTM, etc. The functions may also include an activation function that adjusts the output of the node.

Each of the functions in neural network 100 may be associated with different weights (e.g., kernel coefficients) that are adjustable during training. After an input is provided to neural network 100 and passes through neural network 100 in the forward direction, the results may be compared to the training labels or other values in the training set to determine the neural network's performance. The process of prediction or generation may be repeated for other samples in the training sets to compute the overall value of the objective function in a particular training round. In turn, neural network 100 performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., neural network 100 has converged) or after a predetermined number of rounds for a particular set of training samples. The trained neural network 100 can be used for making inferences/generation or another suitable task for which the model is trained.

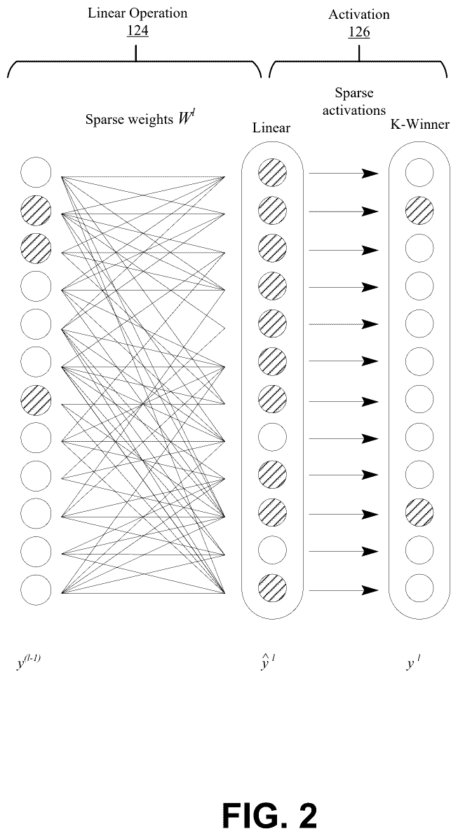

FIG. 2 illustrates the concept of sparsity in a neural network 100, according to one embodiment. One or both of the input activation tensor 120 and the weight tensor 122 may be sparse. A circle in FIG. 2 represents an element in a tensor where the shaded ones represent elements that have non-zero values, and the empty ones represent elements that have a zero value. Specifically, in a neural network 100 with L hidden layers, the notation y^{l} denotes output activation tensor 128 from layer l and y^{l-1} denotes the output activation tensor 128 in the preceding layer l−1 or the input activation tensor 120 of layer l. W^{l} and u^{l} represent respectively weight tensor 122 and biases for each node. In a neural network node 110 that has a dense process tensor W^{l}, the feed-forward outputs are calculated as follows:

$${\hat{y}}^{l} = {W}^{l} \cdot {y}^{l - 1} + {u}^{l} \qquad Equation 1$$

$${y}^{l} = f ( {\hat{y}}^{l} ) \qquad Equation 2$$

where ƒ is any activation function, such as a sparsity function, tanh or ReLU; and ŷ^{l} is the output of the linear operation before an activation function is applied.

### Example Processes for Efficient Sparse Tensor Operations

One way to efficiently process sparse tensors in neural networks is to prioritize allocation of memory space for storing processed outputs based on their likely importance. In one or more embodiments, the importance is represented by the magnitudes of the output values where the higher magnitude represents a higher importance. When a k-WTA function is used as the activation function to generate the output activation tensor, only a subset of the highest output values is retained whereas the remaining output values are set to zero values. Since the output elements with the highest magnitudes are retained in the output activation whereas the remaining output elements are set to zero, output elements likely to yield higher values may be prioritized for storing when the available memory space is limited. The memory space may be taken up by accumulators for storing intermediate and final output values, and hence, the total number of the accumulators may be preset to keep the memory usage within a desired limit. For this purpose, the sparse input tensor and the sparse weight tensor may be sorted based on their magnitude, and then earlier elements in the two tensors are given priority in terms of processing while processing of subsequent elements in the two tensors may be skipped when the allocated memory space is filled up.

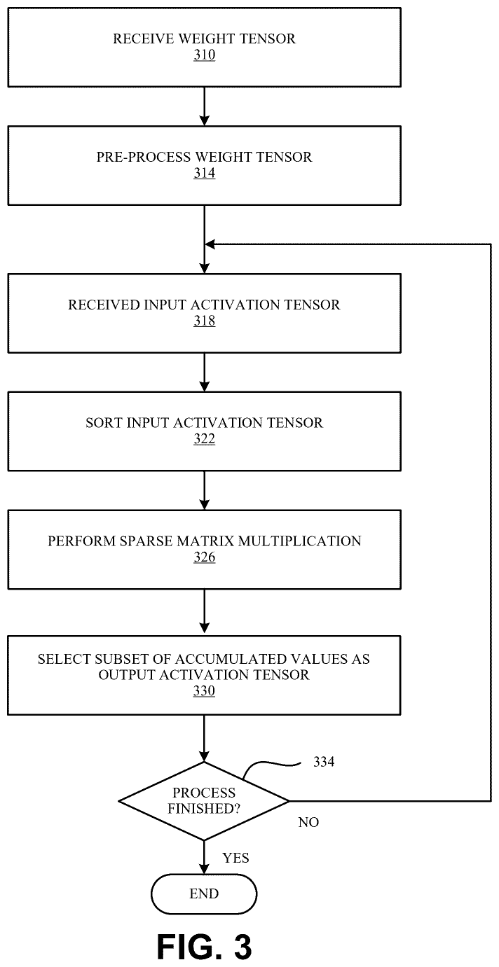

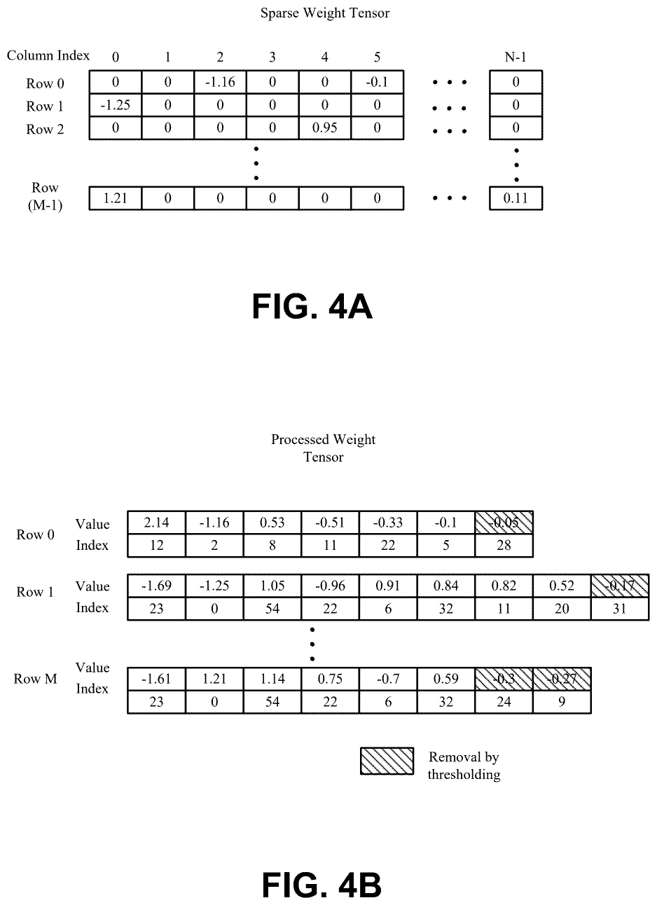

FIG. 3 is a flowchart illustrating processing a sparse activation tensor and a sparse weight tensor in a neural network, according to an embodiment. The processing of the tensors in FIG. 3 may include a convolution operation followed by selecting a subset of the convolution results. In a neural network, a weight tensor remains the same during its runtime. After the weight tensor is received 310, the weight tensor is pre-processed 314 to remove zero-valued elements and sort its elements in a descending order of magnitude with or without filtering as described below with reference to FIGS. 4A and 4B. Such preprocessing of the weight tensor may be performed offline during a compilation process before executing the neural network for interference or content generation.

During the runtime of the neural network, the input activation tensor is received 318 at a node or a layer of the neural network. To facilitate the prioritizing of the processing of elements in the input activation that are likely to yield important outputs, elements in the input activation tensor may also be sorted 322 in a descending order of magnitude. After or during sorting, the elements of the activation tensor with values that are below a threshold may also be filtered.

Then the sparse matrix multiplication is performed 326 between the input activation tensor and the weight tensor. Pseudo-code for performing the sparse matrix multiplication is provided below:

| | |
|---|---|
| 100 | def sparse_matmul(activations, weights, kacc): |
| 101 | |
| 102 | acc = zeros(kacc) |
| 103 | ht = { } |
| 104 | max_offset = 0 |
| 105 | for (a, i) in activations: |
| 106 | for (w, j) in weights[i]: |
| 107 | if j in ht: |
| 108 | v = w * a |
| 109 | offset = ht[j] |
| 110 | acc[offset] += v |
| 111 | elif len(ht) < kacc: |
| 112 | v = w * a |
| 113 | ht[j] = max_offset |
| 114 | acc[max_offset] = v |
| 115 | max_offset += 1 |
| 116 | |
| 117 | return ht, acc |

In this pseudo code, the preprocessed activation tensor a is represented in a dense data structure that contains the activations and their indices where the activations are sorted by magnitude. For example, the preprocessed activation tensor may be represented as a list of tuples such as [(1.11,5), (−0.6, 11), (0.49,9), (−0.39, 0)] where the first element of the tuple represents an activation, and the second element of the tuple represents a row index of the activation. The iterator on line 105 iterates through each of the sorted activations and their indices in sequence. The preprocessed weight tensor w is also represented in a data structure that contains the weight values and their indices of each row of weight values where the weights are sorted by magnitude. The preprocessed weight tensor may be represented as a list of tuples where the first element of the tuple represents the weight value, and the second element of the tuple represents a column index. The iterator on line 106 iterates through the weight values and indices for row i of the weight tensor. kacc is an integer representing the maximum number of elements in an accumulator array.

For a weight in column j of the weight tensor, the offset of its corresponding accumulator in the accumulator array is determined by a hash function, as shown in line 109. The pseudo code returns a hash table ht and the accumulator array acc. The keys of the hash table are indices of the non-zero output activations, and the entries of the hash table ht are offset locations in the accumulator table that contain the values of accumulators that sum the multiplied products of the corresponding weights and activations.

According to the pseudo code, the largest values of both weight elements and activation elements are processed first since both the activation tensors and the weight tensors are sorted in the order of descending magnitude. When all the available accumulators in the accumulator array are used up to accumulate the products associated with weights of earlier tuples, no further accumulator is associated with products resulting from subsequent weights of later tuples.

After the sparse matrix multiplication is complete, a subset of accumulated values in the accumulators is selected 330 to include it in an output activation tensor. Since both activations and weights were previously sorted by their magnitude, the accumulators corresponding to the largest values of both weights and activations are likely to contain the highest accumulated values. If the number of top k^{O} accumulated values be selected using the k-WTA function is significantly less than kacc (for example, kacc=4*k^{O}), then the subset of accumulator values selected from kacc accumulators would approximate the result of performing the k-WTA function on all products of the activations and the weights. If kacc is equal to the number of columns in the weight matrix, the final result would include exactly the same result as performing k-WTA on full matrix multiplication output results of the activation tensor and the weight tensor. In one or more embodiments, the number of accumulator elements kacc may be set to tune the accuracy of the k-WTA operation to an acceptable level.

After selecting the output activation, the process proceeds to determine 334 if all the input activation tensor is processed. If there are remaining input activation tensors to process, the process returns to receive 318 the next input activation tensor and repeats the subsequent operations.

The processing according to the pseudo code is advantageous, among other reasons, because (i) the number of multiplications is reduced, (ii) the number of floating-point comparisons is reduced, and (iii) the memory bandwidth associated with the accumulators is reduced. First, the calculation of w*a is only performed to the extent the calculation is relevant to producing a subset of output indices, and hence, the process reduces the number of computations. In fact, after the hash table is filled with the maximum number of entries (kacc), line 111 will always return false and none of the operations in lines 112-115 are executed. For example, at 95% output sparsity (if k^{O} is 5% of the number of weight columns) and kacc is 4*k^{O}, then on average lines 112-115 are executed only 20% of the time. Further, the number of accumulators kacc may be set to store only a subset of accumulated values. Such a reduced number of accumulators also enable k-WTA function to be performed with fewer floating-point comparisons between the accumulated values. The process also reduces memory bandwidth because fewer accumulators relative to the result of a full matrix multiplication are accessed. The number of accumulators to be stored may be reduced so that all or most of the accumulators fit into a cache memory (e.g., L1 cache). By using the cache memory, the speed of accessing the accumulators and subsequent processing using the values stored in the accumulators would be increased significantly relative to storing the accumulators in a system memory.

FIG. 4A is a diagram illustrating a sparse weight tensor, according to an embodiment. In this example, the sparse weight tensor has N columns and M rows. Most of the elements in the sparse weight tensors are zero while only selected elements have non-zero values. During the pre-processing of the sparse weight tensors, each row of weights is sorted in a descending order of magnitude, and stored with their column indices in the original sparse weight tensor, as shown in FIG. 4B. For example, in the first row (row 0) of the processed sparse weight tensor, an element in column 12 has the largest magnitude of 2.14 followed by an element in column 2 that has the next largest magnitude of −1.16. These values are stored with their corresponding column indices in the original sparse weight tensor (shown in FIG. 4A).

In FIG. 4A, a threshold may further be applied to each row to filter out the weights having absolute values below a threshold. For example, in the first row (row 0) of the preprocessed sparse weight tensor, column 28 may have a magnitude below a threshold of 0.09, and hence, is discarded. In some embodiments, different rows of weights are filtered using different thresholds. Such thresholds may be set in various ways. One example of determining the thresholds is by computing statistics such as a mean magnitude and standard deviation of magnitude of sorted values for each row. Then, a row-specific threshold is determined based on the statistics. For example, any weight values whose magnitude is below the mean minus three times the standard deviation may be filtered out. Alternatively, these thresholds may be determined iteratively by using test input activations to generate output activations, and comparing the output activations with accurate output activations for accuracy. The thresholds may be adjusted and then the resulting accuracy determined in an iterative manner to constrain the accuracy to an acceptable range. In other embodiments, the same threshold is applied across different rows of the weight tensor.

The activation tensor may be pre-processed to sort elements in each of its columns in a descending order of magnitude. Filtering may also be performed per each column to remove activations below a threshold. As in the preprocessing of the weight tensor, the same or different thresholds may be applied to each column of activations or the same threshold may be applied to all columns of activations.

In some embodiments, the filtering of weights or activations based on thresholds may be omitted and only sorting may be performed during the preprocessing of one or both the weight tensor and the activation tensor.

Although the process is described with reference to the pseudo code using the magnitude of the elements to sort the weight tensor and the input activation tensor, other criteria may be used for sorting. For example, instead of sorting the elements based on the magnitude of elements, a saliency metric for each weight may be used to sort elements in a row of the weight tensor or a column of the input activation tensor. An example saliency metric may be determined by the following equation:

$$average ( abs ( input\_activation \_i * weight\_ij ) ) \qquad Equation ( 1 )$$

where a test input activation tensor is used for each weight. In another example, the saliency metric may be computed using the following equation:

$$abs ( prob ( column j is a winner ) * weight\_ij ) \qquad Equation ( 2 )$$

where prob(column j is a winner) represents the duty cycle of column j after a subsequent k-WTA operation. In some embodiments, the elements may be sorted using a combination of magnitude and a saliency metric.

Although the process was described above primarily with reference to cases where both the weight tensor and the input activation tensor are sparse, the same principle may be applied to cases where only one of the tensors is sparse.

### Example Computing Device Architecture

The process associated with the pseudo code or its modified versions may be executed on a computing device with dedicated hardware components. Such dedicated hardware components may enable processors with conventional or new architectures to perform operations associated with a neural network in a more efficient and expedient manner. In some embodiments, the processors may perform sparse matrix multiplications with the assistance of the dedicated hardware components while performing other computing operations in a conventional manner.

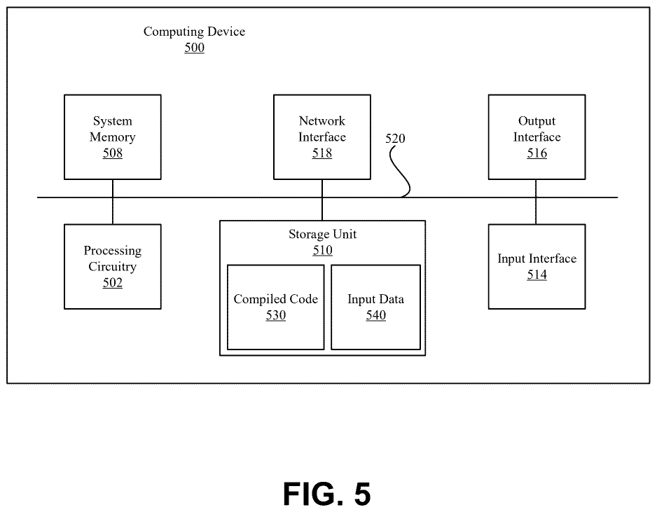

FIG. 5 is a block diagram of an example computing device 500 for processing one or more sparse neural networks, according to an embodiment. Computing device 500 may be a server computer, a personal computer, a portable electronic device, a wearable electronic device (e.g., a smartwatch), an IoT device (e.g., a sensor), a smart/connected appliance (e.g., a refrigerator), a dongle, a device in edge computing, a device with limited processing power, etc. Computing device 500 may include, among other components, processing circuitry 502, system memory 508, a storage unit 510, an input interface 514, an output interface 516, a network interface 518, and a bus 520 connecting these components. In various embodiments, computing device 500 may include additional, fewer or different components.

Some of the components in this disclosure may at times be described in a singular form while other components may be described in a plural form, various components described in any system may include one or more copies of the components.

Processing circuitry 502 is hardware that performs computing operations including sparse tensor operations. Processing circuitry 502 may include one or more processors such as central processing units (CPUs), neural processing units (NPUs), field-programmable gate arrays (FPGAs), and digital signal processors (DSPs) along with one or more sparse processing circuits.

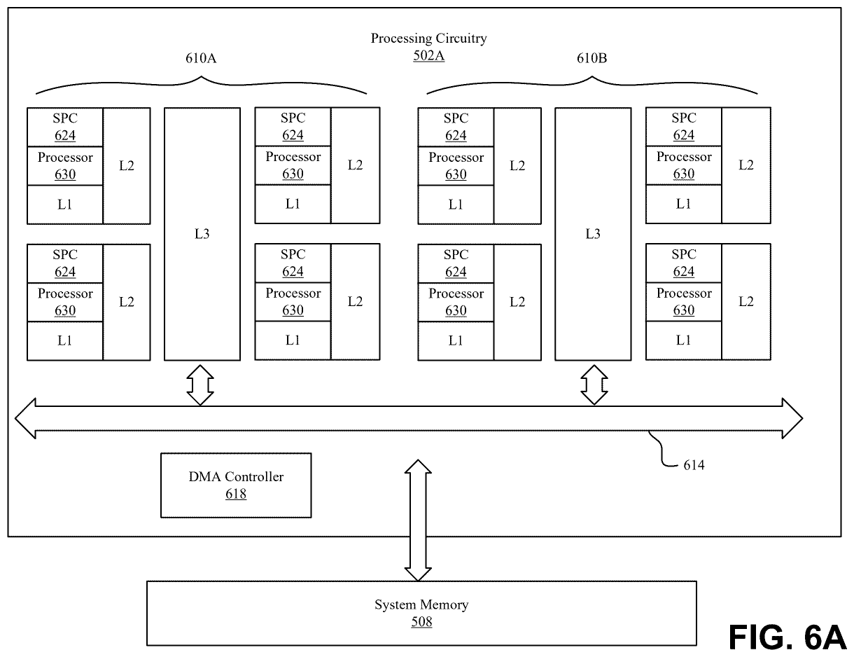

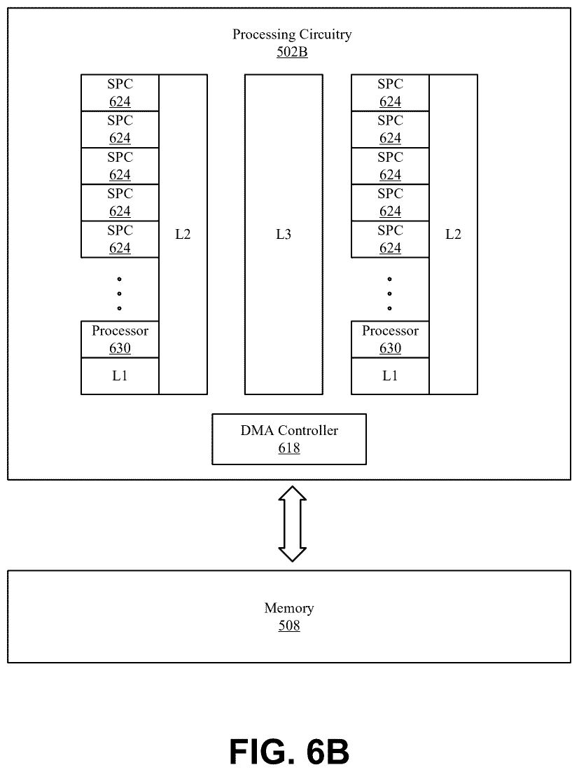

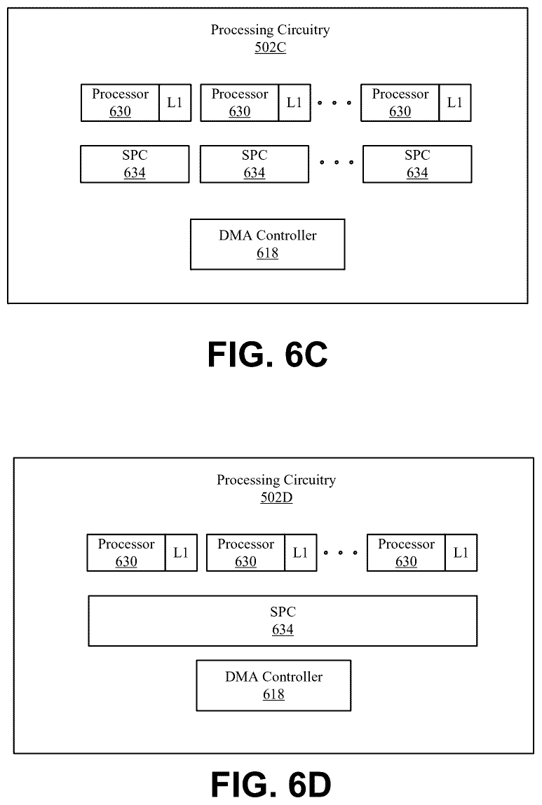

With the assistance of the sparse processing circuits, the one or more processors in processing circuitry 502 may perform sparse tensor operations more efficiently and expediently. Processing circuitry 502 may also perform operations other than sparse tensor operations including, but not limited to, dense tensor operations, managing resources of computing device 500, and execution of various applications. Example architectures of processing circuitry 502 are described below in detail with reference to FIGS. 6A through 6D.

System memory 508 includes circuitry for storing instructions executed by processing circuitry 502 and data processed by processing circuitry 502. System memory 508 may take the form of any type of memory structure including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. System memory 508 may be part of a memory system that further includes a memory controller and one or more levels of cache memory.

Storage unit 510 may be a persistent storage for storing data and software applications in a non-volatile manner. Storage unit 510 may take the form of read-only memory (ROM), a hard drive, flash memory, or another type of non-volatile memory device. Storage unit 510 stores the operating system of the computing device 500, various sets of compiled code 530 and input data 540. Compiled code 530, when executed by processing circuitry 502, may instantiate and execute various applications including machine learning models including neural networks. Machine learning models instantiated by compiled code 530 may include different types of algorithms for making inferences based on the training of the models. Examples of machine learning models include regression models, random forest models, support vector machines (SVMs) such as kernel SVMs, and artificial neural networks (ANNs) such as convolutional neural networks (CNNs), recurrent neural networks (RNNs), autoencoders, long short-term memory (LSTM), and reinforcement learning (RL) models.

By way of example, a machine learning model may receive sensed inputs representing images, videos, audio signals, sensor signals, data related to network traffic, financial transaction data, communication signals (e.g., emails, text messages and instant messages), documents, insurance records, biometric information, parameters for a manufacturing process (e.g., semiconductor fabrication parameters), inventory patterns, energy or power usage patterns, data representing genes, results of scientific experiments or parameters associated with the operation of a machine (e.g., vehicle operation) and medical treatment data. The machine learning model may process such inputs and produce an output representing, among others, identification of objects shown in an image, identification of recognized gestures, classification of digital images as pornographic or non-pornographic, identification of email messages as unsolicited bulk email (‘spam’) or legitimate email (‘non-spam’), prediction of a trend in the financial market, prediction of failures in a large-scale power system, identification of a speaker in an audio recording, classification of loan applicants as good or bad credit risks, identification of network traffic as malicious or benign, identity of a person appearing in the image, processed natural language processing, weather forecast results, patterns of a person's behavior, control signals for machines (e.g., automatic vehicle navigation), gene expression and protein interactions, analytic information on access to resources on a network, parameters for optimizing a manufacturing process, predicted inventory, predicted energy usage in a building or facility, web analytics (e.g., predicting which link or advertisement users are likely to click), identification of anomalous patterns in insurance records, prediction on results of experiments, indication of illness that a person is likely to experience, selection of contents that may be of interest to a user, indication on prediction of a person's behavior (e.g., ticket purchase, no-show behavior), prediction on election, prediction/detection of adverse events, a string of texts in the image, indication representing a topic in text, and a summary of text or prediction on reaction to medical treatments. The underlying representation (e.g., photo, audio, etc.) can be stored in system memory 508 and/or storage unit 510.

Input interface 514 receives data from external sources such as a database, the Internet or sensor. Output interface 516 is a component for providing the result of computations in various forms (e.g., image or audio signals). Computing device 500 may include various types of input or output interfaces, such as displays, keyboards, cameras, microphones, speakers, antennas, fingerprint sensors, touch sensors, and other measurement sensors. Input interface 514 may directly work with a machine learning model to perform various functions. Output interface 516 may be in communication with humans, robotic or artificial intelligence (AI) agents or other computing devices.

Network interface 518 enables computing device 500 to communicate with other computing devices via a network. The networks may include, but are not limited to, Local Area Networks (LANs) (e.g., an Ethernet or corporate network) and Wide Area Networks (WANs). When multiple nodes/layers or components of a machine learning model are embodied in multiple computing devices, information associated with various processes in the machine learning model may be communicated between computing devices via the network interface 518. Although only a single computing device is illustrated in FIG. 5, the functions and operations of computing device 500 may be distributed across multiple computing devices communicating over network interface 518.

FIGS. 6A through 6D are block diagrams of processing circuitry 502, according to various embodiments. In FIG. 6A, the processing circuitry 502A includes, among other components, multiple circuit blocks 610A, 610B (hereinafter collectively referred to as “circuit blocks 610” or individually as “circuit block 610”), a direct memory access (DMA) controller 618 and an internal bus 614. Although only two circuit blocks 610 are illustrated in FIG. 6A, many more circuit blocks 610 may be provided in processing circuitry 502A to expand capability. The circuit blocks 610 may communicate data with each other or other components in processing circuitry 502 via internal bus 614, and communicate with system memory 508 under the coordination of DMA controller 618.

Each of circuit blocks 610 may include, among other components, a hierarchy of caches (including L1, L2 and L3), multiple processors 630, and multiple sparse processing circuits (SPCs) 624. In the embodiment of FIG. 6A, each SPC 624 is associated with one processor via interconnects (not shown). L1 cache is located closest to processor 630 followed by L2 cache and L3 cache, and are also connected to processor 630 and SPC 624 via the interconnects. SPC 624, processor 630, L1 cache and L2 cache collectively form a subblock. Four subblocks and L3 cache form circuit block 610.

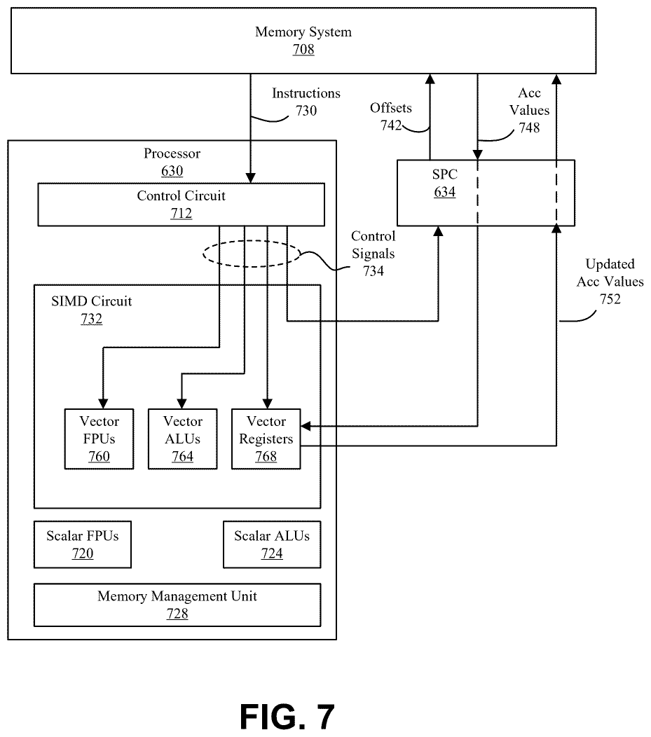

Processor 630 is a circuit that executes instructions to perform various operations. Processor 630 may be embodied, for example, as central processing unit (CPU), graphics processing unit (GPU), field-programmable gate array (FPGA), neural processing unit (NPU), application-specific integrated circuit (ASIC) or a combination thereof. The number of processors 630 included in a subblock or circuit block 610 may vary. In the example of FIG. 6A, each of the four processors 630 in a subblock are assigned to a different L1 and L2 cache but share the same L3 cache. The detailed structure of processor 630 is described below with reference to FIG. 7.

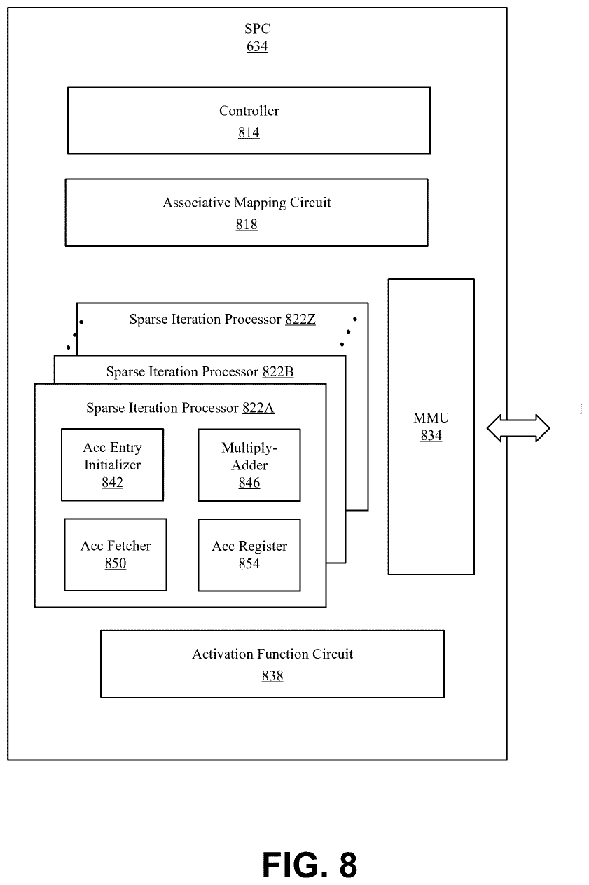

SPC 624 is a dedicated circuit that assists one or more assigned processors 630 to perform sparse tensor operations more efficiently. In the example of FIG. 6A, a single SPC is assigned to a single processor 630. SPC 624 may access data in L1, L2 or L3 cache via corresponding processor 630. Alternatively, SPC 624 may access data in the cache directly without involving processor 630. The detailed structure and operations of SPC 624 are described below in detail with reference to FIG. 8.

DMA controller 618 is a circuit that enables processing circuitry 502 to manage data access via system memory 508. DMA controller 618 facilitates the transfer of data between processing circuitry 502 and system memory 508 with only limited intervention or no intervention from processors 630.

FIG. 6B is a block diagram of processing circuitry 502B, according to another embodiment. In the embodiment of FIG. 6B, multiple SPCs 624 are assigned to a single processor 630. Otherwise, the functions and operations of SPC 624, processor 630, cache L1, L2, L3, and DMA controller 618 are the same as those of FIG. 6A.

FIG. 6C is a block diagram of processing circuitry 502C, according to yet another embodiment. In the embodiment of FIG. 6C, processing circuit 502C includes only a single level of cache (e.g., L1 cache). Each of SPCs 634 is assigned to one processor 630 to facilitate processor 630 to perform sparse tensor operations. The functions and operations of L1 cache, SPCs 634, processors 630 and DMA controller 618 are the same as those of FIG. 6A.

FIG. 6D is a block diagram of processing circuitry 502D, according to yet another embodiment. The embodiment of FIG. 6D is substantially identical to the embodiment of FIG. 6C except that a single SPC 634 operates with multiple processors 630. In this embodiment, when the sparse tensor operations are invoked simultaneously by multiple processors 630, the sparse tensor operations may be executed by these processors 630, for example, in a time-divisional manner. Otherwise, the functions and operations of L1 cache, SPCs 634, processors 630 and DMA controller 618 are the same as those of FIG. 6A.

The architecture and components of processing circuitry 502 described above with reference to FIGS. 6A through 6D are merely illustrative. Various modifications may be made to the structures and/or components of processing circuitry 502.

### Example Processor and Sparse Processing Circuit

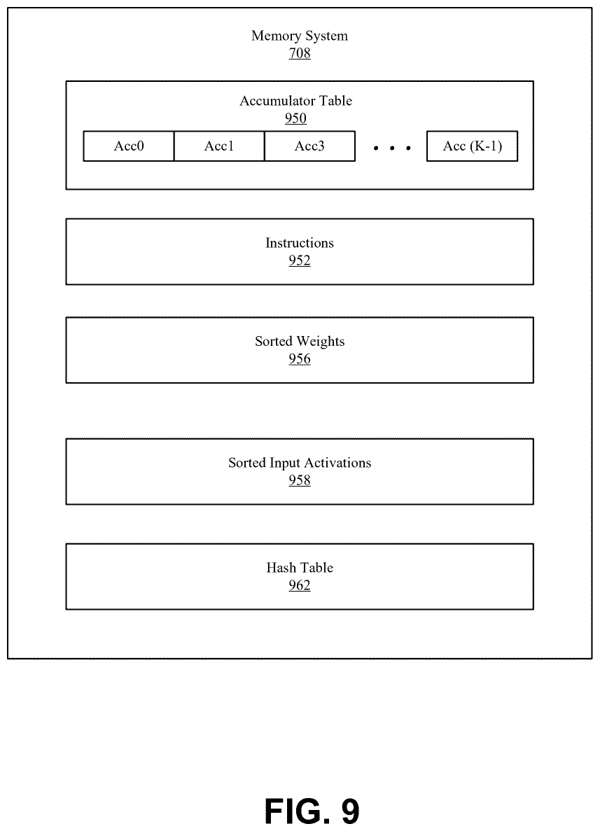

FIG. 7 is a block diagram illustrating processor 630, SPC 634 and memory system 708 and their interactions, according to an embodiment. Components related to performing sparse tensor operations are illustrated in FIG. 7, and some components (e.g., DMA controller) are omitted herein for the sake of brevity. Memory system 708 refers to the collection of components that store instructions and data associated with the operations of processor 630 and SPC 634. Depending on the embodiments, memory system 708 may include combinations of L1, L2, L3 caches, and memory system 508. Memory system 708 may also include a cache controller (not shown) that manages the storage and movement of data across L1, L2, L3 caches and system memory 508. Example data and instructions stored in memory system 708 are described below in detail with reference to FIG. 9.

Processor 630 is a circuit that executes instructions to perform various operations including the sparse tensor operations. In FIG. 7, processor 630 has a CPU architecture but this is merely illustrative. Processor 630 may have other structures such as the GPU, NPU, FPGA and ASIC. Processor 630 of FIG. 7 may include, among other components, control circuit 712, SIMD circuit 732, scalar floating-point units (FPU) 720, scalar arithmetic logic units (ALU) 724 and memory management unit (MMU) 728. Processor 630 may also include components not illustrated in FIG. 7 or omit some components illustrated in FIG. 7. To perform the sparse tensor operations more efficiently, processor 630 receives and decodes single instruction, multiple data (SIMD) instructions associated with the sparse tensor operations.

Control circuit 712 is a circuit that controls the operations of processor 630. Control circuit 712 may include an instruction decoder that decodes instructions 730 received from memory system 708. Instructions 730 may include SIMD instructions that may be decoded and sent to SIMD circuit 732 and SPC 634. In addition to the instruction decoder, control circuit 712 may include, among other components, a clock generator, registers and counters, and signal generators. Control circuit 712 manages the fetch-decode-execute cycle by generating control signals 734 that synchronize and direct operations of other components of processor 630 and SPC 634.

SIMD circuit 732 processes multiple data elements in parallel according to SIMD instructions, as decoded by the instruction decoder of control circuit 712. Once the instruction decoder identifies a SIMD instruction from instructions 730, the instruction decoder sends control signals 734 to SIMD circuit 732 and SPC 634. SIMD circuit 732 then generates results by applying the same arithmetic or logical operation to an entire vector of data elements in one clock cycle, accelerating data-parallel tasks associated with sparse tensor processing. For this purpose, SIMD circuit 732 may include, among other components, vector FPUs 760, vector ALUs 764, and vector registers 768. Vector FPUs 760 and vector ALUs 764 are pipelined to perform various arithmetic and logical operations on floating-point numbers or integer data. Vector registers 768 store multiple data elements in a packed format and function as sources and destinations of SIMD operations, and may have dedicated banks to enable parallel access and reduce latency during execution of the SIMD operations.

Scalar FPUs 720 and scalar ALUs 724 are hardware components that perform arithmetic and logical operations on floating-point numbers or integer data based on single instruction, single data (SISD) operations. These components handle arithmetic or logic operations one at a time in contrast to vector FPUs 760 and vector ALUs 764, which perform the same operations across different data items in parallel. Scalar FPUs 720 and scalar ALUs 724 may be used, for example, to sort columns of the input activation tensors by magnitude or the saliency metric.

MMU 728 is a hardware component that translates virtual memory addresses into physical addresses in memory system 708. MMU 728 functions as an intermediary to memory system 708 to manage virtual memory, allowing operations as if the operations have dedicated, contiguous address spaces. By handling this translation, the MMU supports multitasking, process isolation, and dynamic memory management without direct software intervention.

### Example Operations of Processor and Sparse Processing Circuit

In order to perform the sparse tensor operations described above with reference to FIG. 3, processor 630 may receive and execute instructions to sort weights along one dimension (e.g., rows of weights) and store them in memory system 708 and/or move the sorted weights to an appropriate cache (e.g., L1), if the weights are already sorted offline. If the weights are not sorted offline, processor 630 may perform operations to sort and/or filter the weights of the kernels for processing. Processor 630 may also receive and execute instructions to sort and/or filter activations along another dimension (e.g., columns of activations). Such sorting/filtering instructions may be SISD instructions that are executed using scalar FPUs 720 and/or scalar ALUs 724.

Processor 630 may also receive instructions to instantiate and/or clear tables or arrays in memory system 708 and other circuitry. One of such instructions may be a SIMD instruction that instructs processor 630 to clear, in parallel, multiple entries of the tables or arrays in memory system 708 and SPC 634. The tables or arrays to be instantiated or cleared include one or more of an accumulator table, a hash table, and filter registers, as described below with reference to FIGS. 9 through 11B.

Subsequently, processor 630 may receive another SIMD instruction to set accumulators in the accumulator table. Specifically, in response to such a SIMD instruction, values may be set in a hash table or a dedicated circuit to map indices of weights along a dimension (e.g., column indices) to offset locations 742 of the accumulator table or addresses of content addressable memory (CAM). Using the offset locations 742 or the addresses, accumulators or entries in the CAM to store accumulated values of products (e.g., resulting from multiplying weights and activations) are assigned or initialized. By using the SIMD instructions, processor 630 and SPC 634 may perform tensor operations on multiple sets (e.g., 8 or 16) of weight values and activations in parallel by using SIMD circuit 732. In this way, instructions for the sparse tensor operation may be simplified while efficiently performing repetitive computations by parallel processing, which reduces the overhead associated with individually processing a large number of weights and activations.

For this purpose, processor 630 may send control signal 734 to SPC 634 so that SPC 634 may take actions to assist the sparse tensor operation. Specifically, SPC 634 may (i) initially set accumulators to store partial or full sums of products (e.g., by generating a hash table) resulting from the multiplication of weights and activations, (ii) determine the correct accumulators to update using offset locations 742, and (iii) retrieve current accumulator values 748 stored in an accumulator at the offset locations 742 of the accumulator table (e.g., accumulator table 950 in FIG. 9). SPC 634 may then send current accumulator values 748 to vector registers 768 so that vector FPUs 760 of SIMD circuit 732 may read the current accumulator values from vector registers 768, add the products of corresponding activations and weights to the current accumulator values, and store the updated accumulator values in vector registers 768. Updated accumulator values 752 in vector registers 768 are then sent to the accumulators at corresponding offset locations of the accumulator table directly or via SPC 634 for storing.

In alternative embodiments, processor 630 may receive offsets from SPC 634 and directly receive current accumulator values 748 for updating from memory system 708 via MMU 728 without further intervention of SPC 634.

In some embodiments, the tasks of multiplying the input activations and the weights followed by adding these products to current accumulator values may be performed by SPC 634 instead of processor 630. Such delegation of tasks to SPC 634 may enable processor 630 to preserve its computing resources for other operations.

### Example Structure of Sparse Processing Circuit

SPC 634 is a circuit that performs operations to support the sparse tensor operations of processor 630. SPC 634 may include additional components to further offload tasks associated with sparse tensor operations from processor 630. Alternatively, SPC 634 may include fewer components with reduced capabilities but with a smaller footprint. FIG. 8 is a block diagram of SPC 634, according to one embodiment with more components to offload more tasks from processor 630. In the embodiment of FIG. 8, SPC 634 may include, among other components, a controller 814, an associative mapping circuit 818, sparse iteration processors 822A through 822Z (hereinafter collectively referred to as “sparse iteration processors 822”), an activation function circuit 838 and a memory management unit (MMU) 834. Depending on embodiments, SPC 634 may include additional components not illustrated in FIG. 8 or omit some of the components illustrated in FIG. 8.

Controller 814 is a circuit that controls and coordinates the operation of components in SPC 634. Specifically, controller 814 receives control signal 734 from processor 630 and sets control registers in the components to perform SIMD operations. In some embodiments, a separate controller 814 of SPC 634 may be omitted and the control operations of SPC 634 may be performed by control circuit 712 of processor 630.

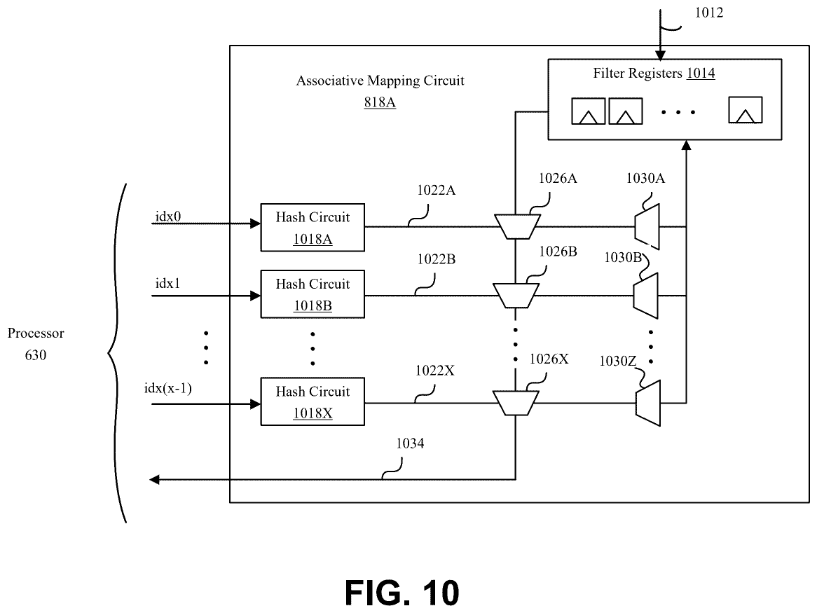

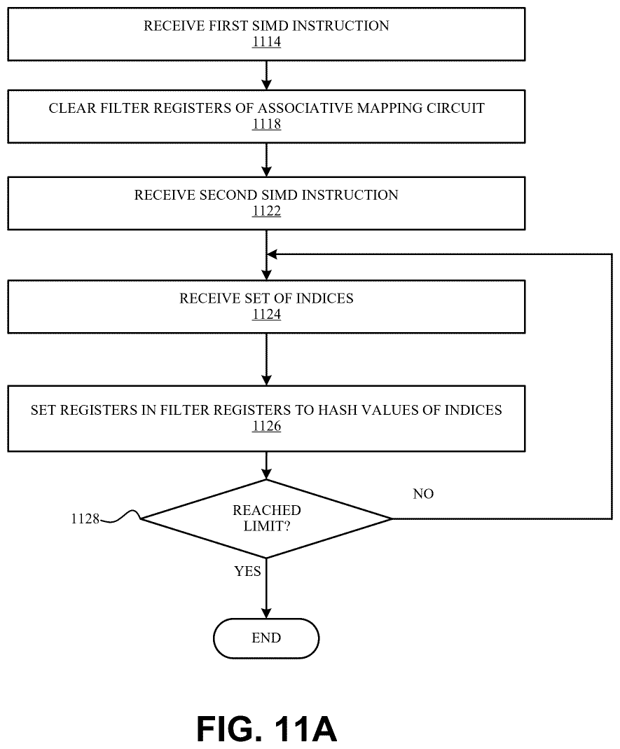

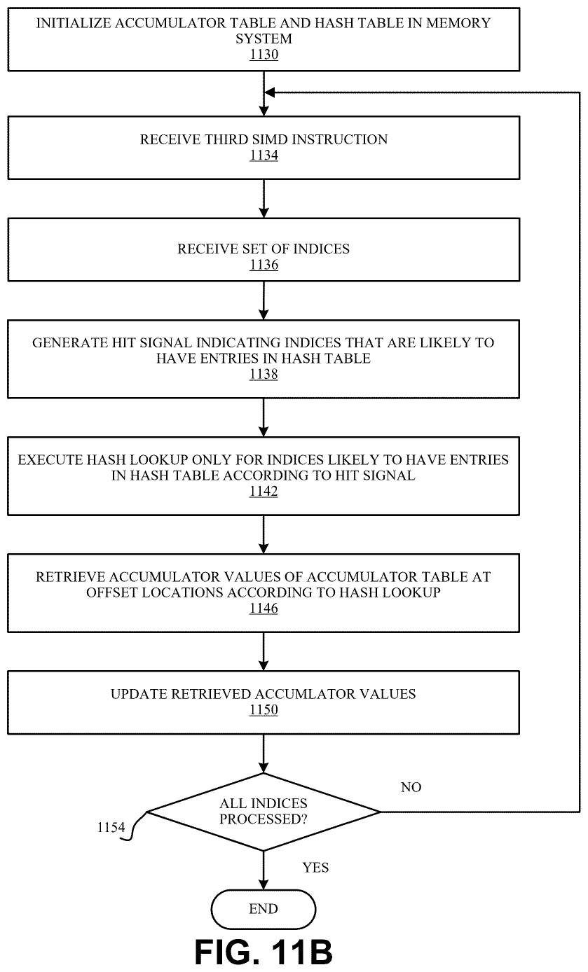

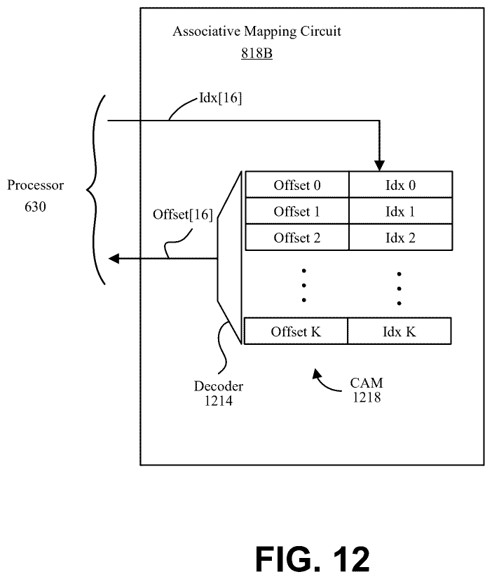

Associative mapping circuit 818 is a circuit that performs or facilitates the determination of accumulator offsets in the accumulator table stored in memory system 708. The offsets of the accumulators are set as new accumulators to accommodate the sums of products resulting from multiplication of activations and weights with new column indices. In one embodiment, associative mapping circuit 818 performs a fast pre-filtering operation to filter out hash lookups for certain weights and/or activations, as described below in detail with reference to FIGS. 10 through 11B. In another embodiment, associative mapping circuit 818 provides offset locations 742 in response to receiving hashed values of indices of the weight tensor along a dimension (e.g., weight column indices), as described below in detail with references to FIGS. 12 through 14. Associative mapping circuit 818 may be compatible with SIMD instructions so that associative mapping circuit 818 provides a signal associated with multiple weight indices or multiple offset locations in a single cycle.

Sparse iteration processors 822 are circuits dedicated to performing part of the sparse tensor operations in an efficient manner. Sparse iteration processor 822 may perform operations corresponding to lines 107-115 of the pseudo code, but in a parallel manner across multiple data sets. In one embodiment, each of the sparse iteration processors 822 performs operations on column indices of weights in a row where the weights are sorted by criteria such as magnitude or a saliency metric on a row-by-row basis. Each of the sparse iteration processors 822 may include, among other components, accumulator entry initializer 842, a multiply-adder 846, an accumulator fetcher 850, and accumulator register 854.

Accumulator entry initializer 842 is hardware, software, firmware or a combination thereof for initializing an accumulator in the accumulator table. In one embodiment, accumulator entry initializer 842 receives an index of a weight, generates a hash value of the index, and stores the hash value in the hash table in memory system 708. The index used for this purpose may be a column index of the weight that is being multiplied with activations in a row of the input activation tensor. In another embodiment where no separate hash table is used, accumulator entry initializer 842 receives an index, and clears a memory element of associative mapping circuit 818. In one or more embodiments, accumulator entry initializer 842 may stop initializing further accumulators when the number of initialized accumulators has reached a predetermined limit. After the predetermined limit has been reached, sparse iteration processor 822 skips further assignment of an accumulator and omits performing of operations (e.g., multiply and add operations) for further weights and activations that involve the new accumulators. In this way, the total number of accumulators may be limited and reduce the total memory space used by accumulators.

Multiply-adder 846 is a circuit that multiplies a weight and an input activation to generate a product, and then adds the product to a current accumulator value of a corresponding accumulator, which was previously initialized by accumulator entry initializer 842. When a partial sum is already stored in the accumulator, the accumulator value is retrieved by accumulator fetcher 850 and the new product is added to the retrieved accumulator value. Although the embodiments are described herein primarily with reference to multiply and add operations, in other embodiments, this circuit may be replaced with another circuit that is dedicated to performing other mathematical operations. In some embodiments, the circuit may omit multiplication and instead perform only add operations. Such modification may be applicable when either one or both of the weights and the input activations are binary, for example.

Accumulator fetcher 850 is hardware, software, firmware or a combination thereof for fetching a current accumulator value from an accumulator corresponding to an index. For this purpose, accumulator fetcher 850 may operate in conjunction with associative mapping circuit 818 to fetch the accumulator value corresponding to the index, and store the fetched accumulator value in accumulator register 854 for further operations.

Accumulator register 854 is a memory circuit that stores the fetched accumulator value received from memory system 708, and also stores the updated accumulator value as processed by other components (e.g., multiply-adder 846) of sparse iteration processor 822. MMU 834 may operate in conjunction with accumulator register 854 to store accumulator values in accumulator registers of different sparse iteration processors 822 and also read updated accumulator values from accumulator registers of these sparse iteration processors 822 for sending to the accumulator table in memory system 708.

Although sparse iteration processors 822 are described as including a multiply-adder, in other embodiments, multiply-adder 846 may be omitted from sparse iteration processors 822 and their operations may be performed by SIMD circuit 732 in processor 630 instead. In such embodiments, sparse iteration processor 822 forwards the offset locations of accumulators corresponding to indices to processor 630. In response, processor 630 retrieves the accumulator values and updates the accumulator values followed by storing the updated accumulator values in the accumulator table of memory system 708 via MMU 728.

Activation function circuit 838 is a dedicated circuit specialized in performing an activation function on the finalized accumulated values stored in accumulators. The activation function performed by activation function circuit 838 may include, among other functions, a k-WTA function, a step function, a sigmoid function, a hyperbolic tangent function (tanh), and rectified linear unit functions (ReLU). For example, when a k-WTA function is used as the activation function, activation function circuit 838 may be embodied as a bitonic sorting network to select the top k number of finalized accumulated values. In alternative embodiments, activation function circuit 838 may be included in processor 630 instead of SPC 634. In some embodiments, activation function circuit 838 may be absent from both SPC 634 and processor 630, and its function may be performed instead by executing an algorithm on processor 630.

### Example Data in Memory System

Memory system 708 stores various data associated with the sparse tensor operations. Memory system 708 may include a hierarchy of caches (e.g., L1, L2, L3) or a single layer of cache and system memory 508. Depending on the data used by processing circuitry 502, various data sets may be moved into caches or moved from caches to system memory 508. Embodiments improve the efficiency and the speed of sparse tensor operations by reducing the size of the accumulator table stored in memory system 708. By reducing the size of the accumulator table, the accumulator table in its entirety or a large portion thereof may be moved to cache (e.g., L1 cache) for faster access by processor 630 or SPC 634.

FIG. 9 is a diagram illustrating data stored in memory system 708, according to an embodiment. Memory system 708 may store, among other data, an accumulator table 950, instructions 952, sorted weights 956, sorted input activations 958 and a hash table 962. Memory system 708 may store other datasets such as output activations and various look-up tables used with non-linear activation functions. Further, depending on embodiments, certain datasets may be omitted from memory system 708 or are stored in different components. For example, in some embodiments, hash table 962 may be removed and its data may be stored in memory elements of associative mapping circuit 818 instead.

Accumulator table 950 stores accumulator values of K number of accumulators Acc0 through Acc(K−1). The accumulators may be identified by their offsets of addresses relative to the address of first accumulator Acc0. The accumulator values may be read and updated by processor 630 and/or SPC 634. After the sparse tensor operation (e.g., matrix multiplication) of the weight tensor and the input activation tensor is finished, accumulator table 950 stores the final accumulator values. These final accumulator values may then be processed by an activation function to generate an output activation tensor. In some embodiments, the total number of accumulators K may be set so that the accumulators in their entirety may be stored in L1 cache so that the accumulator values may be accessed expediently. In other embodiments, the size of the accumulators K is set so that the accumulators are saved across different caches and system memory. The size of the accumulators K may be set, for example, to meet a predetermined accuracy threshold.

Instructions 952 are retrieved by one or more processors 630 for decoding and execution. Instructions 952 may include at least one SIMD instruction to perform parallel operations in processor 630 and/or SPC 634.

Sorted weights 956 of a sparse weight tensor are stored in memory system 708. The weights of the sparse weight tensor may be generated by sorting and/or filtering off-line during compilation or optimization of machine learning models by computing device 500 or other computing devices. In one or more embodiments, such sorting and/or filtering of weights are performed on a row-by-row basis, as described above with reference to FIG. 4B. Since the weight tensors generally remain the same in the machine learning models, sorting and/or filtering of the sparse weight tensors may be performed off-line. In some embodiments, the sorted weights 956 may be generated on-line while the machine learning model is being executed on computing device 500.

Sorted input activations 958 are generated by sorting and/or filtering the sparse input activation tensor. Since the input activation tensors generally change during execution of the machine learning models, the input activation tensors are sorted and/or filtered on-line during the execution of the machine learning for inference. In one or more embodiments, the sorting and/or filtering operations are performed per each column of the input activation tensor.

In some embodiments, hash table 962 is stored in memory system 708. Hash table 962 may store, as keys, hash values of column indices of the weights used in computing products to be added to the accumulator values, and, as values, offset locations of corresponding accumulators in accumulator table 950. The hash values of the column indices may be obtained from processor 630 or accumulator entry initializer 842 of SPC 634. To expedite the hash value lookup, pre-filtering may be performed to select a subset of indices that meet a certain condition and perform hash lookup only on the subset of indices, as described below in detail with reference to FIG. 10.

### Example Associative Mapping Circuit Using Pre-Filtering

FIG. 10 is a block diagram of associative mapping circuit 818A that uses filter registers to pre-filter indices to undergo hash lookup operations, according to an embodiment. When indices are received, associative mapping circuit 818A performs a SIMD operation to preliminarily determine whether these indices may have corresponding entries in hash table 962. The indices that are determined not to have corresponding entries are skipped from hash lookup operations involving hash table 962, and therefore, the hash lookup operation may be simplified.

Associative mapping circuit 818A may include, among other components, hash circuits 1018A through 1018X (hereinafter collectively referred to as “hash circuits 1018”), filter registers 1014, decoders 1026A through 1026X (hereinafter collectively referred to as “decoders 1026”) and encoders 1030A through 1030Z (hereinafter collectively referred to as “encoders 1030”). When a first SIMD instruction is received at processor 630, associative mapping circuit 818A receives clear signal 1012 indicating that registers in filter registers 1014 be cleared.

When a second SIMD instruction is received at processor 630, processor 630 sends a set of indices idx0 through idx(x−1) to associative mapping circuit 818A. The indices are, for example, column indices of weights to be processed with activations of the input activation tensor. In response to the second SIMD instruction, processor 630 or SPC 634 executes operations to generate hash values of the indices of weights to be processed as keys, sends the generated hash values to encoders 1030 via input lines 1022A through 1022X and stores the hash values in filter registers 1014. The hashed values then set registers in filter registers 1014. In this way, filter registers 1014 function as a key-only hash table. Each of the registers in filter registers 1014 is set only once, and subsequent indices resulting in the same hash values are discarded to avoid collisions. If the weights and the input activations are sorted and/or filtered based on magnitude or a saliency metric, the operations on earlier weights and activations are likely to result in more important accumulator values. Therefore, the earlier weights with higher magnitude or saliency metrics are prioritized for storing in filter registers 1014 when the number of hash values that may be stored in filter registers 1014 is limited. Subsequent weights after filling up filter registers 1014 may be disregarded. In one embodiment, the number of hash values to be stored in filter registers 1014 is the same as the number of accumulators in accumulator table 950.

When a third SIMD instruction is received at processor 630, processor 630 sends indices associated with accumulators whose accumulator values are to be updated. These indices are sent to hash circuits 1018 to produce hash values, which are compared with the hash values in filter registers 1014. As a result of the comparison, a single comparison bit is generated for each of the indices by filter registers 1014. If the comparison bit for an index has a certain value (e.g., zero) for an index, this means a definite hash miss for the index according to filter registers 1014 and a full hash lookup operation using hash table 962 for this index may be skipped by processor 630. Conversely, if the comparison bit has another value (e.g., one) for the index, then there is a possibility that the index is one of the keys in hash table 962, and therefore, a full hash lookup operation is to be performed by processor 630 using hash table 962 to retrieve the offsets. The bit signals for the received indices are multiplexed into a hit signal 1034 with a bitwidth corresponding to the number of received indices by decoders 1026, and sent to processor 630 so that processor 630 may perform a full hash table lookup process on selected indices.

FIGS. 11A and 11B are flowcharts illustrating processes of using filter registers 1014 for pre-filtering, according to an embodiment. FIG. 11A is a flowchart illustrating the process of setting up filter registers 1014 for pre-filtering operations, according to an embodiment. Processor 630 receives 1114 the first SIMD instruction. In response to receiving the first SIMD instruction, filter registers 1014 in associative mapping circuit 818A are cleared 1118.

Then, processor 630 receives 1122 a second SIMD instruction to set accumulators in accumulator table 950. A set of indices (e.g., column indices of weights) associated with the weight tensor is received 1124. In response to receiving the indices, hash values corresponding to the indices are determined and filter registers 1014 are set 1126 to store the hash values. Then, it is determined 1128 whether the limited number of memory spaces in 1014 has been reached. If the limit has not been reached, then the process returns to receive 1122 another second SIMD instruction and a next set of indices, and the subsequent processes are repeated. When it is determined that the limit has been reached, the process is terminated without adding new hash values to filter registers 1014. After the processes of FIG. 11A are terminated, filter registers 1014 store the hash values of indices (e.g., column indices of a subset of non-zero weights) to be used for pre-filtering indices to select indices to undergo hash lookup operations by processor 630.

FIG. 11B is a flowchart illustrating processes of performing pre-filtering of hash lookup operations using the hash values stored in filter registers 1014, according to one embodiment. First, accumulator table 950 and hash table 962 are initialized 1130. A third SIMD instruction is received 1134 followed by receiving 1136 of a set of indices of weights. In response, associative mapping circuit 818A generates hash values of the indices, checks whether these hash values were previously stored in filter registers 1014 during processes, as described above in reference to FIG. 11A. As a result, associative mapping circuit 818A generates 1138 a hit signal indicating which of the indices in the set of indices are likely to have corresponding hash values in hash table 962. In one embodiment, associative mapping circuit 818A performs such operations on 16 indices as a set, and the hit signal includes 16 bits indicating which of these 16 indices are likely to have corresponding hash values in hash table 962.

Processor 630 or SPC 634 receives the hit signal and then executes 1142 hash lookup operations only on indices in a subset of indices that are likely to have corresponding entries in hash table 962, as indicated by the hit signal. No hash lookup operation is performed on one or more indices that are indicated by the hit signal as not having corresponding hash values in 962. In one or more embodiments, the hash lookup operations are performed by processor 630 by a software algorithm that checks matches of indices as keys in hash table 962.

After the hash lookup operations are performed, accumulator values in accumulator table 950 that correspond to the pre-filtered indices are retrieved 1146. Then, the products of the weights of the pre-filtered indices and the activations are computed, and the products are added to the retrieved accumulator values to update 1150 the accumulator values. The updated accumulator values are then stored in accumulator table 950. Such operations may be performed in parallel across multiple pre-filtered indices.

Then it is determined 1154 if all the indices have been processed. If it is determined that there are remaining indices to be processed, the process returns to receiving 1134 the next set of indices and the subsequent processes are repeated. If it is determined that all the indices have been processed, then the process is terminated.

The steps and their sequences described above with reference to FIGS. 11A and 11B are merely illustrative. For example, the second and third instructions may include the indices, and hence, no separate step of receiving the indices is performed. Alternatively, there may be no limit to the number of accumulators, in which case, the process 1128 of determining whether the accumulator limit has been reached may be omitted.

### Example Associative Mapping Circuit Using Content Addressable Memory

FIG. 12 is a block diagram of associative mapping circuit 818B including a content addressable memory (CAM) to determine the offset locations of accumulators in an accumulator table, according to an embodiment. CAM 1218 enables high-speed retrieval of offsets by searching through its entries in parallel. The offsets of the accumulators may be stored and retrieved at a high speed in an efficient manner using CAM 1218 compared to using software hash operations.

CAM 1218 is a circuit that stores the indices at addresses that convert to offset locations of accumulators. The memory addresses in CAM 1218 have a one-to-one correlation with the offsets, and hence, CAM addresses and offsets to locations of accumulators can be used interchangeably herein. Further, since CAM 1218 functions as a hash table, CAM 1218 obviates the use of hash table 962 in memory system 708. By removing hash table 962 from the memory system, the memory usage may be further reduced.

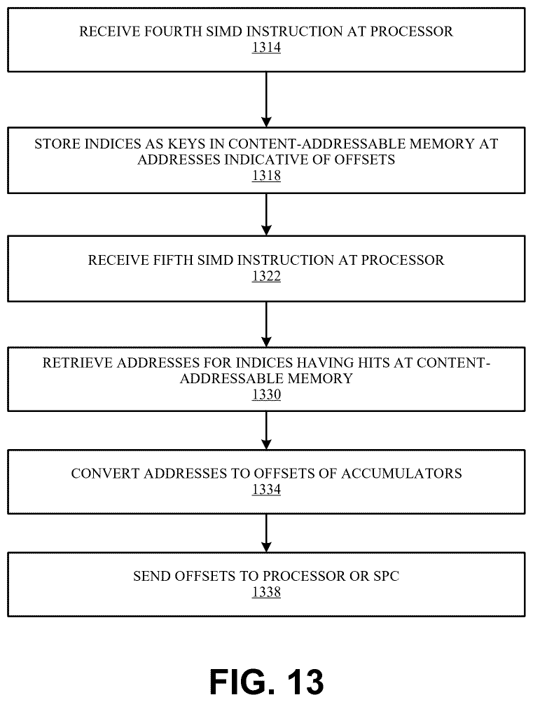

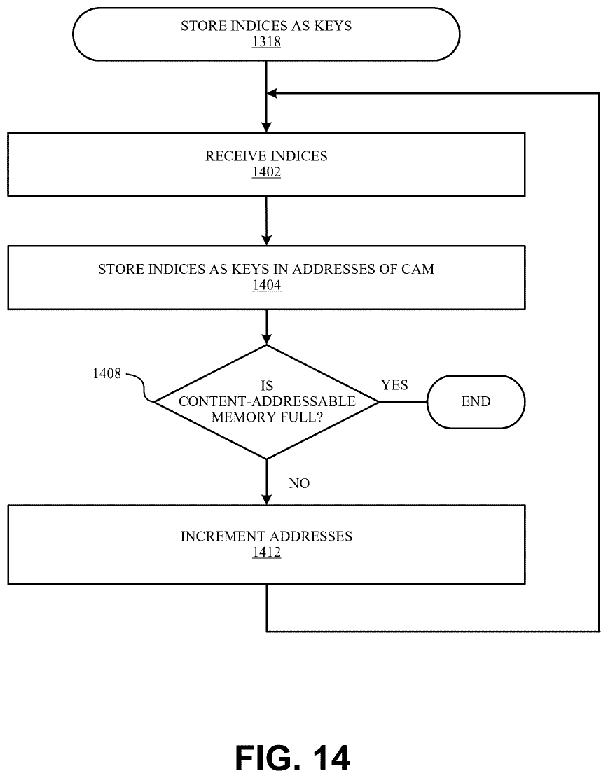

FIG. 13 is a flowchart illustrating processes of using CAM 1218 to store and retrieve offset locations of the accumulators, according to an embodiment. CAM 1218 receives the indices as keys and also addresses (or offsets) in CAM 1218 where these indices should be stored. Specifically, a fourth SIMD instruction is received 1314 at processor 630. In response, CAM 1218 stores 1318 a set of indices from sorted weights 956 at its designated addresses indicative of offsets to the accumulator, as described below in detail with reference to FIG. 14. The maximum number of accumulators may be set by limiting the number of keys in CAM 1218.

After storing the indices in CAM 1218, a fifth SIMD instruction may be received 1322 to retrieve offsets of indices. Indices associated with accumulators are received separately or as a part of the fifth SIMD instruction. The indices are provided to CAM 1218. In response, CAM 1218 searches the entries in CAM 1218 in parallel to determine if the indices have hits. CAM 1218 returns an output via decoder 1214 indicating which of the indices have hits, and for any indices with hits, CAM 1218 also retrieves 1330 the addresses at which the indices are stored as keys. The addresses may be converted 1334 into the offsets of accumulators in accumulator table 950 at CAM 1218 or by other circuit components of processing circuitry 502. The offsets of the accumulators are then sent 1338 to processor 630 or SPC 634 to retrieve the accumulator values from accumulator table 950 based on the offsets. Processor 630 or SPC 634 performs further operations such as updating the accumulator values by adding products and saving the updated accumulator values in accumulator table 950, as described above with reference to FIG. 11B.

FIG. 14 is a flowchart illustrating the processes of storing 1318 the indices as keys, according to one embodiment. A set of indices of sorted non-zero weights is received 1402. Then the received indices are stored at addresses of CAM 1218 in a sequential order. For example, an earliest index is stored at the lowest address of CAM 1218 and the next index is stored in the next higher address of CAM 1218. After the indices are stored as keys, it is determined 1408 if the maximum number of entries are stored in CAM 1218.

If not, the addresses to store the next set of indices are incremented 1412, and the process returns to receiving 1402 the next set of indices to repeat the subsequent processes. If it is determined that the maximum number of entries are stored in CAM 1218, the operation terminates.

The steps and their sequences described above with reference to FIGS. 13 and 14 are merely illustrative. For example, the offsets of accumulators may be inferred from the addresses of CAM 1218, and hence, the process of converting 1334 the addresses to the offsets may be omitted.

### ALTERNATIVE EMBODIMENTS

In alternative embodiments, instead of using absolute indices to indicate locations of weights or activations, relative indexing may be used where the locations of the weights or activations are represented by the distance from previous weights or activations. The same principles described above may be applied when the sparse weight tensor and/or the sparse activation tensor are converted into formats using relative indexing.

In alternative embodiments, the locations of the accumulators may be identified by information other than offsets. For example, a fixed random seed from which the offsets may be derived is used to identify the locations of the accumulators in an accumulator table.

Upon reading this disclosure, those of skill in the art will appreciate still additional alternative designs for processing nodes. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A method of performing sparse tensor operations, comprising:
receiving indices of non-zero elements in a first tensor along a first dimension of the first tensor, the first tensor derived from a sparse weight tensor to at least remove zero elements from the sparse weight tensor;
generating mapping of a subset of the indices to locations of accumulators stored in a memory system by parallel processing the subset of indices in a plurality of first circuits;
retrieving accumulator values from the mapped accumulators of the memory system;
updating the retrieved accumulator values by processing the non-zero elements of the first tensor corresponding to the received indices with non-zero elements of a second tensor in parallel;
storing the updated accumulator values in the mapped accumulators of the memory system; and
applying an activation function to the stored accumulator values to generate an output tensor.

2. The method of claim 1, further comprising skipping mapping of the indices other than the subset of the indices to the accumulators in the memory system.

3. The method of claim 1, wherein the first tensor has the non-zero elements along the first dimension sorted by one or more criteria of importance to place a first non-zero element with first importance ahead of a second non-zero element with second importance lower than the first importance and having a same index in the second dimension of the first tensor that is perpendicular to the first dimension.

4. The method of claim 3, wherein generating the mapping of the subset of the indices comprises selecting one or more indices of the non-zero elements along the first dimension for each index along the second dimension based on magnitude or saliency metric representing the importance of the non-zero elements for the mapping.

5. The method of claim 1, further comprising sorting non-zero elements of an input sparse activation tensor according to one or more criteria of importance to generate the second tensor sorted along a second dimension of the second tensor perpendicular to the first dimension of the second tensor, wherein a first non-zero element with first importance is placed ahead of a second non-zero element with second importance lower than the first importance.

6. The method of claim 5, wherein the one or more criteria include magnitude or a saliency metric of each of the non-zero elements.

7. The method of claim 4, further comprising:
generating hash values of the subset of the indices along the second dimension of the first tensor;
storing the generated hash values in a pre-filtering circuit;
responsive to receiving request indices corresponding to accumulator values to be retrieved for updating, determining which of the request indices have corresponding hash values in the pre-filtering circuit; and
sending a hit signal by the pre-filtering circuit indicating which of the request indices have corresponding hash values in the pre-filtering circuit to skip hash lookup for retrieving accumulator values associated with at least a subset of the request indices without the corresponding hash values in the pre-filtering circuit.

8. The method of claim 1, wherein the applying of the activation function comprises:
selecting a subset of the stored accumulator values based on magnitude;
retaining the selected subset of the accumulator values in the output tensor; and
zeroing out unselected ones of the accumulator values in the output tensor.

9. The method of claim 1, further comprising storing the mapping of the subset of the indices to the locations of the accumulators in a content addressable memory.

10. The method of claim 1, further comprising:
receiving a first single instruction, multiple data (SIMD) instruction responsive to which the mapping is generated; and
receiving a second SIMD instruction responsive to which the accumulator values are retrieved.

11. A computing device comprising:
one or more processors;
a sparse processing circuit comprising:
a plurality of iteration processor circuits configured to generate mapping of a subset of indices of non-zero elements in a first tensor to locations of accumulators by parallel processing the subset of indices, the first tensor derived from a sparse weight tensor to at least remove zero elements from the sparse weight tensor, and
an associative mapping circuit configured to assist or perform retrieving of accumulator values stored in the accumulators; and
memory configured to store:
the non-zero elements in the first tensor and indices of the non-zero elements along a first dimension,
the accumulated values of the accumulators, and
instructions that cause the one or more processors or the sparse processing circuit to:
retrieve accumulator values from accumulators corresponding to received indices,
update the retrieved accumulator values by processing the non-zero elements of the first tensor corresponding to the received indices with non-zero elements of a second tensor in parallel,
store the updated accumulator values in the mapped accumulators, and
apply an activation function to the stored accumulator values to generate an output tensor.

12. The computing device of claim 11, wherein the instructions further cause the sparse processing circuit to skip mapping of the indices other than the subset of the indices to the accumulators in the memory.

13. The computing device of claim 11, wherein the first tensor has the non-zero elements along the first dimension sorted by one or more criteria of importance to place a first non-zero element with first importance ahead of a second non-zero element with second importance lower than the first importance and having a same index in the second dimension of the first tensor that is perpendicular to the first dimension.

14. The computing device of claim 13, wherein the instructions that cause the one or more processors or the sparse processing circuit to generate the mapping of the subset of the indices comprise instructions that cause the one or more processors or the sparse processing circuit to select one or more indices of the non-zero elements along the first dimension for each index along the second dimension based on a magnitude or saliency metric representing the importance of the non-zero elements for the mapping the one or more criteria include magnitude or a saliency metric of the non-zero elements.

15. The computing device of claim 11, wherein the instructions further cause the one or more processors to: sort non-zero elements of an input sparse activation tensor according to one or more criteria of importance to generate the second tensor sorted along a second dimension of the second tensor perpendicular to the first dimension of the second tensor, wherein a first non-zero element with first importance is placed ahead of a second non-zero element with second importance lower than the first importance.

16. The computing device of claim 14, wherein the associative mapping circuit is configured to:
store generated hash values of a subset of the indices along the second dimension;
responsive to receiving request indices corresponding to accumulator values to be retrieved for updating, determine which of the request indices have corresponding hash values in the associative mapping circuit; and
send a hit signal indicating which of the request indices have corresponding hash values to skip hash lookup for retrieving accumulator values associated with at least a subset of the request indices without the corresponding hash values in the associative mapping circuit.

17. The computing device of claim 11, wherein the one or more processors or the sparse processing circuit comprises a bitonic sorting network circuit that selects a subset of the stored accumulator values based on magnitude, wherein the selected accumulator values are retained in the output tensor and unselected accumulator values are zeroed out in the output tensor.

18. The computing device of claim 11, wherein the associative mapping circuit comprises a content addressable memory that stores the generated mapping.

19. The computing device of claim 11, wherein the one or more processors comprise at least one decoder circuit configured to:
decode a first single instruction, multiple data (SIMD) instruction responsive to which the mapping is generated; and
decode a second SIMD instruction responsive to which the accumulator values are retrieved.

20. A non-transitory computer-readable storage medium storing instructions thereon, the instructions when executed by one or more processors cause the one or more processors to:
receive indices of non-zero elements in a first tensor along a first dimension of the first tensor, the first tensor derived from a sparse weight tensor to at least remove zero elements from the sparse weight tensor;
generate mapping of a subset of the indices to locations of accumulators stored in a memory system by parallel processing the subset of indices in a plurality of first circuits;
retrieve accumulator values from the mapped accumulators of the memory system;
update the retrieved accumulator values by processing the non-zero elements of the first tensor corresponding to the received indices with non-zero elements of a second tensor in parallel;
store the updated accumulator values in the mapped accumulators of the memory system; and
apply an activation function to the stored accumulator values to generate an output tensor.
